(19) United States
(12) Patent Application Publication
(10) Pub. No.: US 2008/0208646 A1
(43) Pub. Date: Aug. 28, 2008

(54) METHOD FOR INCREASING PRODUCTIVITY AND SAFETY IN THE MINING AND HEAVY CONSTRUCTION INDUSTRIES

(76) Inventors: Ralph E. Thompson, Salt Lake City, UT (US); Ralph E. Thompson, Salt Lake City, UT (US)

Correspondence Address: ANTOINETTE M. TEASE, P. O. BOX 51016, BILLINGS, MT, 59105, US

(21) Appl. No.: 11/679,989

(22) Filed: Feb. 28, 2007

(51) Int. Cl. G06Q 50/00

(52) U.S. Cl. 705/7

(57) ABSTRACT

A method for increasing productivity and safety in the mining and heavy construction industries comprising: evaluating equipment operator skills; correlating the evaluated operator skills to skill levels; calculating an average site skill level; correlating the average site skill level to an incident rate; establishing equipment costs based on the incident rate; projecting equipment costs for different average site skill levels; comparing actual to projected equipment costs; using the average site skill level to generate a productivity factor for each class of equipment; calculating production costs for a class of equipment based on the productivity factors; calculating production costs for different productivity factors; comparing actual to projected production costs to generate cost-benefit information for a manager deciding whether to implement a training program; and generating a report with recommended training based on the skill evaluations and desired equipment cost and/or productivity factor goals.

### BACKGROUND OF THE INVENTION

1. Field of the Invention

The present invention relates generally to the fields of mining and heavy construction, and more specifically, to a method for increasing productivity and safety in the mining and heavy construction industries.

2. Description of the Related Art

In the mining and heavy construction industries today, there is no mechanism by which managers can tie employee knowledge and skills directly to equipment costs and productivity rates. For example, companies in these industries are required to report incident (accident) rates to the U.S. Mine Safety and Health Administration (MSHA) and/or other regulatory agencies, but managers have no way to take that information and translate it directly into equipment costs and/or productivity factors for individual operators, for particular types of equipment, or for the operation as a whole. Having the ability to do that would allow managers to provide focused training to those operators whose productivity factors are not optimal and to thereby decrease overall equipment costs.

A current phenomenon of the mining industry is that the workforce is aging and expansion is being slowed by a lack of qualified workers, in part because of the specialized skills required for some mining jobs and in part due to tight labor markets in which workers have other options. This problem is exacerbating a long-term challenge for mines, namely, convincing younger workers to enter a sometimes dangerous profession, often located in rural or remote areas, that is vulnerable to economic cycles. The average age of a U.S. mine worker today is 50 years old, and a large majority of the mining workforce is expected to retire between 2005 and 2015. Thus, there is significant demand for new skilled workers to replace those who will be leaving in the near future. The current labor shortage has heightened the importance of optimizing employee productivity, which can only be accomplished by first assessing the knowledge and skills of an employee (methods for which already exist in prior art), aggregating that information across the entire workforce at a particular mine, and then tying that information to actual dollars spent on equipment costs. Currently, there is no method for tying the skills-and-knowledge assessment to actual operating costs.

Technology has brought many advantages to the mining industry in terms of the evolution of mining equipment, but the productivity factors provided by the equipment manufacturers are based on optimum operator and field conditions. Operation of heavy equipment such as dozers, haul trucks and other similarly complex machinery requires a high level of skill, but the current labor shortage means that this type of machinery is increasingly being operated by less skilled operators. Underground mining poses even greater challenges to the operators due to hazards like poor ventilation, mine collapse, and weather issues. While some mining companies are working hard to mitigate many of these safety issues, others may find it hard to justify an improvement in worker safety at the expense of the bottom line. If it could be shown that worker safety and productivity are aligned such that an improvement in one results in an improvement in the other, mines might more readily embrace processes designed to improve worker safety.

MSHA requires U.S. mines to implement worker training programs in health and safety issues. In a world of constantly changing technological and industrial training needs, it is critical to ensure that an effort is applied to assess training needs and develop methods to resolve training deficiencies. The goal is to produce a highly effective yet simple and cost-conscious means of training personnel and/or implementing improvements to existing operations. This goal will result in improved production, compliance with safety standards, and, ultimately, a better trained workforce. Training is an important factor in the economic survival of any business, but most training programs are not measurable in terms of the resulting economic benefits to the business. Consequently, it becomes very difficult for the training manager to justify the expense of an excellent training program.

What is needed is a method for taking the results of knowledge and skill assessments of equipment operators and translating that information into economic data that can be used by managers to increase productivity and decrease operational costs. Accordingly, it is an object of the present invention to provide such a method. It is a further object of the present invention to provide a method that can be used by managers as a tool in assessing productivity of the operation at an aggregate level, as it relates to specific types of equipment, and in relation to individual employees. Is it is a further object of the present invention to allow managers to target training where it will have the greatest positive impact on productivity and equipment costs. It is a further object of the present invention to provide a method that works within existing safety management systems to reduce incident rates and related excessive maintenance costs, and increase mechanical availability (productivity) of equipment fleets. It is a further object of the present invention to provide the ability to forecast reductions in incident rates and equipment replacement and maintenance costs and an increase in overall operator productivity as operator knowledge and skill improves. With this information, a manager can compare the anticipated training costs to the forecasted savings before making the decision to invest time and money in training.

The prior art includes numerous examples of computer-based training, and the novelty of the present invention does not lie in the fact that it utilizes computer-based training. Examples of the prior art in this area include U.S. Patent No. RE39,435 (Berman, 2006); U.S. Pat. No. 6,200,139 (Clapper, 2001); U.S. Pat. No. 6,535,861 (O'Connor et al., 2003); U.S. Pat. No. 6,790,045 (Drimmer, 2004); U.S. Pat. No. 6,801,912 (Moskowitz et al., 2004); U.S. Pat. No. 7,080052 (Busche, 2006); U.S. Pat. No. 7,120,612 (Honda, 2006); U.S. Patent Application Pub. No. 20010039002 (Delehanty, 2001); and U.S. Patent Application Pub. No. 20020146667 (Dowdell et al., 2002).

The prior art also includes examples of analyzing employee performance, either pre-hire or post-hire. The novelty of the present invention does not lie in the fact that it involves an assessment of employee knowledge and skills. Examples of the prior art in this area include U.S. Pat. No. 5,919,046 (Hull, 1999); U.S. Pat. No. 7,082,418 (Levy et al., 2006); U.S. Patent Application Pub. No. 20050273350 (Scarborough et al., 2005); U.S. Patent Application Pub. No. 20060200008 (Moore-Ede, 2006); and U.S. Patent Application Pub. No. 20060210052 (Yamanaka et al, 2006).

The prior art also includes examples of using data to assess or minimize risk or increase productivity. Examples of these types of inventions include U.S. Pat. No. 6,662,141 (Kaub, 2003); U.S. Pat. No. 6,714,894 (Tobey et al., 2004); U.S. Pat. No. 6,876,992 (Sullivan, 2005); U.S. Pat. No. 7,024,388 (Stefek et a., 2006); U.S. Pat. No. 7,139,735 (Ohno et at, 2006); and U.S. Patent Application Pub. No. 20050091176 (Nishiuma et al, 2005). The novelty of the present invention does not lie merely in the fact that it is a tool for assessing risk and increasing productivity based on mitigation of identified risks.

Rather, the novelty of the present invention lies in the fact that it provides a tool—specific to the mining and heavy construction industries—for assessing operator knowledge and skill and then quantifying that information in terms of forecasted incident rates, equipment costs and productivity factors so that managers can make informed decisions relative to targeted training programs. An important corollary to the present invention is that it quantifies for the manager the financial benefits of providing better training and a safer workplace.

### BRIEF SUMMARY OF THE INVENTION

The present invention is a method for increasing productivity and safety in the mining and heavy construction industries comprising: evaluating equipment operator skills at a site; correlating the evaluated operator skills to operator skill levels; calculating an average site skill level for the site; correlating the average site skill level to an incident rate; establishing equipment costs for the site based on the incident rate; calculating incident rates for different average site skill levels; projecting equipment costs for different average site skill levels based on the corresponding incident rates; comparing the equipment costs corresponding to the average site skill level to the projected equipment costs for different average site skill levels; wherein the site utilizes one or more classes of equipment, using the average site skill level to generate a productivity factor for each class of equipment; calculating production costs for a class of equipment based on the productivity factors; calculating production costs for different productivity factors; comparing the actual production costs to the projected production costs to generate cost-benefit information for a manager deciding whether to implement a training program; and generating a report with recommended training based on the skill evaluations and desired equipment cost and/or productivity factor goals established by the site manager.

In a first embodiment, the average site skill level is for a particular class of equipment. In an alternate embodiment, the average site skill level is for the operation as a whole.

In a preferred embodiment, the step of calculating incident rates for different average site skill levels is performed using the following algorithm:

IR=ΣC*200,000/Σt_{EE}−(c₁+c₂+c₃ . . . )*200,000/Σt_{EE}

wherein IR is the incident rate, C represents the cases of reportable incidents for the site, t_{EE} represents the total time in hours of employee exposure at the site, and c_{α} represents the cases of reportable incidents for each individual operator at a particular skill level over the period of his or her employment at the site.

In a preferred embodiment, the step of projecting equipment costs for different average site skill levels involves three categories of incidents; the three categories of incidents are major, serious and minor; each category of incident has an assigned dollar value; the equipment costs for the major incident category are calculated by multiplying the incident rate by the dollar value assigned to that category; the equipment costs for the serious incident category are calculated by multiplying the incident rate by ten and then by the dollar value assigned to that category; and the equipment costs for the minor incident category are calculated by multiplying the incident rate by thirty and then by the dollar value assigned to that category.

In a preferred embodiment, the step of using the average site skill level to generate a productivity factor for each class of equipment is performed using the following algorithm:

PF=O_{Ap}*E

wherein PF is the productivity factor, O_{Ap} represents the operator percentage of efficiency for a particular skill level, and E represents the efficiency for a specified operation based on original equipment manufacturer (OEM) specifications.

In a preferred embodiment, the step of calculating production costs for a class of equipment is performed using the following algorithm:

PC=PF*ΣEq*ΣOt*ΣHCO

wherein PC is the production cost, PF represents the productivity factor for a given class of equipment, Eq represents the number of pieces of equipment in the class, Ot represents the hours of operation for each piece of equipment in the class, and HCO represents the hourly cost of operation for each piece of equipment. Preferably, the hourly cost of operation comprises purchase, finance, depreciation, repair and maintenance, consumables and/or labor costs associated with the equipment.

### BRIEF DESCRIPTION OF THE DRAWING

FIG. 1 is a flow chart depicting the steps of the present invention.

### DETAILED DESCRIPTION OF INVENTION

A. Overview

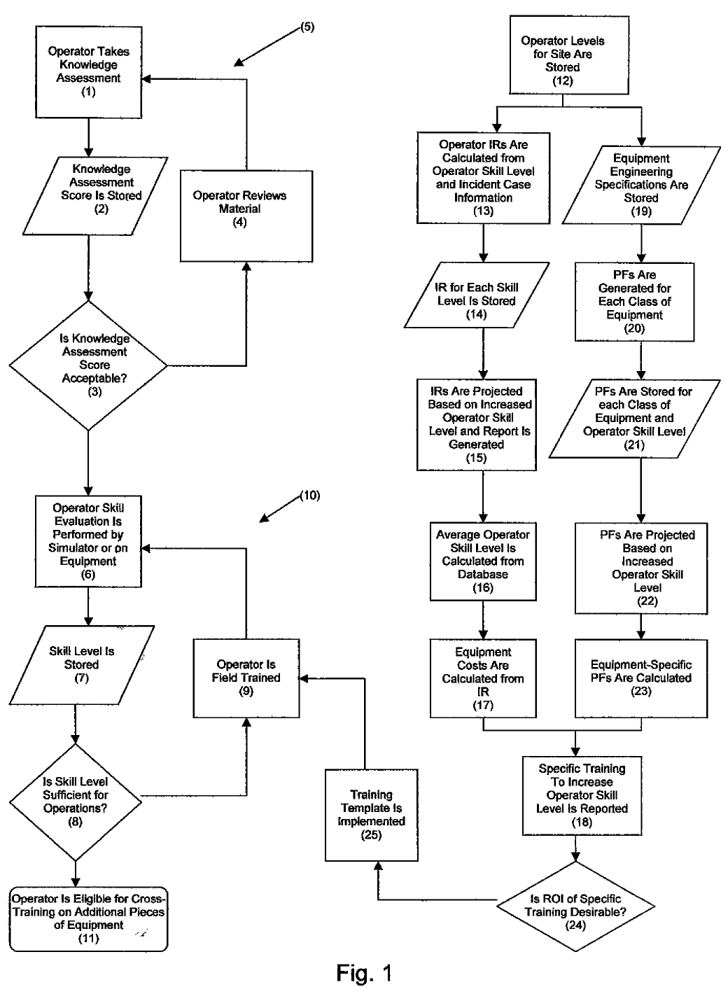

FIG. 1 is a flow chart depicting the components or steps of the present invention. Initially, an operator takes an initial knowledge assessment 1. Next, the knowledge assessment score for that operator is stored in a database 2. At step 3, an evaluation is made as to whether the knowledge assessment score is acceptable. If not, then the operator reviews training material 4 that is focused on specific areas based on the results of his knowledge assessment. This loop 5 continues until the operator attains an acceptable knowledge assessment score.

Next, an operator skill evaluation is performed 6 by simulator and/or on specific equipment. The skill level for that operator is stored in a database 7. At step 8, an evaluation is made as to whether the operator's skill level is sufficient for operations. If not, then the operator undergoes field training 9 for specific equipment. This loop 10 continues until the operator attains an acceptable skill level.

Having passed the knowledge and skill level assessments, the operator is now ready for cross-training on additional pieces of equipment 11. Traditionally, existing training programs do not progress beyond this level. The present invention, however, takes the information gained from the knowledge and skill level assessments and applies proprietary algorithms to predict incident rates, equipment costs, and productivity factors by individual operator, equipment class, and over the operation as a whole. Further, after generation of the initial predictions, predictions for the operation are continuously refined based on improved operator knowledge and skill levels.

The next step in the present invention is to store all of the operator skill levels for the site in a database 12. At step 13, incident rates for various operator skill levels are calculated based on individual operator skill levels for the site (step 12) and incident case information (i.e., reportable accidents) for specific operators. Next, this information is stored 14, preferably in a database.

At step 15, incident rates are projected for higher operator skill levels than those actually existing at the site to quantify the decrease in incident rates associated with a higher average operator skill level. At step 16, the present invention generates an average operator skill level for the site (also called the “average site skill level”). This average may be based on the entire operation or a particular class of equipment, depending on the needs of the customer. At step 17, equipment costs are calculated based on the hypothetical incident rates projected in step 15 and compared to the actual average site skill level from step 16.

Next, targeted training is offered based on reports generated by the present invention 18. These reports include recommendations for training at an operator and task level to achieve the higher operator skill levels used to generate the incident rate and equipment cost projections in connection with steps 16 and 17.

The next aspect of the present invention involves the generation and application of productivity factors. At step 19, engineering specifications for particular types of equipment are stored in a database. These specifications are provided by the original equipment manufacturers (OEMs) and are based on optimum operator and field conditions. Next, productivity factors are generated for each class of equipment 20 based on individual operator skill levels for the site (step 12) and the OEM engineering specifications from step 19. These productivity factors are then stored for each class of equipment and operator skill level 21.

At step 22, productivity factors are projected based on a hypothetical increased average site skill level (step 15). The projected productivity factors are then tied to production costs at step 23. As discussed previously, targeted training is offered based on reports generated by the present invention 18.

With the information generated by the present invention at steps 17 and 23, the manager can make a cost-benefit analysis 24 as to whether to implement the training recommended at step 18. If training is economically justified, the recommended training is implemented 25.

Each of these steps is described in greater detail below.

B. Detailed Description

The first step in the method of the present invention is to test an equipment operator's knowledge and skill in a particular area or areas. The knowledge testing is preferably conducted online. The skill evaluation may be conducted in the field, it may be conducted through the use of simulators, or it may use a combination of field observation and simulators. The skill evaluation is then translated to a skill level. Although there are many ways of correlating a skill evaluation to a skill level, Table 1 illustrates one possible correlation between an operator's skill evaluation and his or her assigned skill level.

TABLE 1

| Skill | Operator | |
|---|---|---|
| Level | Percentage | Notes |
| 1 | Up to and | Operator requires constant supervision. Operator |
| | including 45% | “doubles” with a qualified operator or trainer. |
| 2 | 46 to 60% | Operator requires observation. Supervision should |
| | | be frequent. |
| 3 | 61 to 75% | Operator performs assignments with supervision. |
| | | Requires daily supervision of routine operating |
| | | tasks. |
| 4 | 76 to 85% | Operator performs by assignment. Requires |
| | | minimum supervision. |
| 5 | Greater than | Operator performs by assignment without |
| | 85% | supervision. |

In this example, the percentage represents the percentage of OEM specifications actually achieved by the operator for the particular type of equipment being operated. In other words, an operator with a skill level of 5 achieves at least eighty-five percent (85%) of OEM specifications for the particular type of equipment being operated. In a preferred embodiment, there are five skill levels, but the present invention is not limited to any particular number of skill levels.

The next step is to calculate an incident rate for each existing skill level at the site. For purposes of the present invention, the term “incident rate” refers to any damage incident that is outside the standards established for fair wear and tear when the equipment is operated by highly skilled operators. This correlation is calculated using the following algorithm:

IR=ΣC*200,000/Σt_{EE}=(c₁+c₂+c₃ . . . )*200,000/Σt_{EE}

where:
IR=Incident Rate
C=Cases of Reportable Incidents for Site
t_{EE}=Total Time of Employee Exposure
c_{α}=Cases of reportable incidents for an individual operator at a particular skill level (over the period of his or her employment at the site)
   The above algorithm is equivalent to taking the aggregate cases of reportable incidents at a site for all operators at a particular skill level, and dividing that number by the total employee exposure time in hours to come up with a per hour incident rate, which is in turn multiplied by 200,000 hours to comply with MSHA regulations. This calculation is repeated for each skill level to generate a table similar to that set forth below:

TABLE 2

| Skill | |
|---|---|
| Level | IR |
| 1 | IR¹ |
| 2 | IR² |
| 3 | IR³ |
| 4 | IR⁴ |
| 5 | IR⁵ |

This table sets forth the relationship between skill levels 1-5 and expected incident rates.

By way of example, Table 3 shows hypothetical incident rates for skill levels 2-5:

TABLE 3

| Skill Level | IR |
|---|---|
| 2 | 15 |
| 3 | 8 |
| 4 | 5 |
| 5 | .2 |

In this hypothetical case, level 1 has been eliminated because in actual practice, level 1 operators do not operate independently.

The next step is to calculate the average site skill level, either for the site as a whole or by class of equipment. This calculation is based on the following equation:

$$\frac{Sum of all skill levels}{Total Number of Operators with skill levels} = Average Site Skill Level$$

If the average site skill level falls between two integers (for example, if the average site skill level is 2.4), then the corresponding incident rate is calculated according to the following formula:

[{High IR (15)−low IR (8)}*Decimal number (0.4)]+low IR (8)=IR(10.8)

Thus, according to this example, the incident rate corresponding to an average site skill level of 2.4 would be 10.8.

Next, a projected equipment cost is calculated based on the incident rate corresponding to the average site skill level (i.e., the value taken from Table 2). To calculate equipment cost based on a specific incident rate, it is assumed that for every major incident reported, there are ten (10) serious and thirty (30) minor incidents that are also reported [1]. The present invention assigns an average dollar value to each major, serious and minor incident based on the replacement and labor costs typically associated with such incidents and/or maintenance costs at the particular site.

The following example assumes a site average incident rate of 10.8 and the following costs associated with major, serious and minor incidents:
Major=$100,000
Serious=$60,000
Minor=$15,000

| Incident Rate | Major | Serious | Minor | Total |
|---|---|---|---|---|
| 10.8 | $1,080,000 | $6,480,000 | $4,860,000 | $12,420,000 |

In this example, the equipment costs associated with major incidents are calculated by multiplying the incident rate (10.8) by $100,000. The equipment costs associated with serious incidents are calculated by multiplying the incident rate (10.8) by ten (10) and then by $60,000. Similarly, the equipment costs associated with minor incidents are calculated by multiplying the incident rate (10.8) by thirty (30) and then by $15,000.

A similar calculation may be performed to determine what the equipment costs would be at a projected incident rate of 8.0. In this case the figures associated with major, serious and minor incidents would be as follows:

| Incident Rate | Major | Serious | Minor | Total |
|---|---|---|---|---|
| 8 | $800,000 | $4,800,000 | $3,600,000 | $9,200,000 |

Thus, the profit associated with moving from an incident rate of 10.8 to an incident rate of 8 is $3,220,000:
Incident rate 10.8=$12,420,000
Incident rate 8=$9,200,000
Difference=$3,220,000
   With this information, the manager has the ability to quantify in real dollars the savings that can be achieved by a training program designed to increase the operation's average site skill level, thereby decreasing the operation's incident rate and associated equipment costs.

In another aspect of the present invention, the average site skill level is used to predict a productivity factor, which is then applied to equipment hourly owning and operating costs to calculate the costs of sub-optimal skill levels and the savings associated with training programs designed to raise the average site skill level. The productivity factor allows a manager to predict how many additional pieces of equipment would be required to perform the same work as one piece of equipment operated by an operator with an optimum skill level. As noted above, OEM specifications for equipment generally assume that the equipment will be operated by an operator with an optimum skill level. In practice, the site will experience less productivity than suggested by the OEM specifications if the site's operators possess sub-optimal skill levels. As explained further below, the present invention allows the site manager to quantify the savings associated with increasing the average site skill level for a particular class of equipment.

In the present invention, the productivity factor for each operation for each class of equipment (for example, haul trucks, dozers, rubber tire dozers, loaders, shovels, drag lines, etc.) is calculated according to the following algorithm:

PF−O_{Ap}*E

where:
PF=Productivity Factor
O_{Ap}=Operator Percentage of Efficiency (see Table 1)
E=Efficiency for Specified Operation (from OEM specification)

Table 4 provides an example of the productivity factors for various operations associated with haul trucks. In this table, the skill level corresponding to each operator percentage of efficiency is shown in the first row.

TABLE 4
Haul Trucks
Spotting time is .6–.8 min. - Dump maneuvering time is 1.0–1.2 min.

| | Skill Level/Productivity Factor | | | |
|---|---|---|---|---|
| Operation | 2 | 3 | 4 | 5 |
| 1. Loading Area: Staging/Spotting | 1.5 | 1.3 | 1.1 | 1.0 |
| 2. Hauling: Maximum Speed | 1.3 | 1.1 | 1.0 | 1.0 |
| 3. Dump Area: Approach | 1.5 | 1.3 | 1.1 | 1.0 |
| Backing/Squaring | 1.5 | 1.3 | 1.1 | 1.0 |
| 4. Return: Maximum Speed | 1.3 | 1.1 | 1.0 | 1.0 |
| Average Productivity Factor | 1.42 | 1.22 | 1.06 | 1.0 |

If the average site skill level falls between two integers (for example, if the average site skill level is 2.6), then the corresponding productivity factor is calculated according to the following equation:

PF=[(High PF−Low PF)*Decimal number]|low PF

Example: Avg skill level=2.6
High PF (level 2)=1.42
Low PF (level 3)=1.22
Decimal Number=0.6

[(1.42−1.22)*0.6]+1.22=1.31 PF

Next, to calculate the production cost for a class of equipment, the productivity factor is multiplied by the number of pieces of equipment at issue, the hourly cost per piece of equipment, and the hours of operation for each piece of equipment. In this context, the “hourly cost per piece of equipment” includes purchase, finance, depreciation, repair and maintenance, consumables (e.g., fuel and lubricants), labor and other costs associated with the equipment. The algorithm for this step is set forth below:

PC=PF*ΣEq*ΣOt*ΣHCO

where:
PC=Production Cost
PF=Productivity Factor
Eq=Equipment
Ot=Hours of Operation
HCO=Hourly Cost of Operation

An example is provided below:
Skill level=2.6
PF=1.31
Eq=25
Ot=3,888
HCO=$195

1.31*25*$195*3,888=$24,829,740

Cost to operate fleet (PC)=$24,829,740

By using the same formula for the average desired skill level (for example, 3.0 instead of 2.6), the production savings can be predicted. An example is provided below:
Skill level=3.0
Productivity factor=1.22

1.22*25*$195*3,888=$23,123,880
Cost to operate fleet (PC)=$23,123,880
   A comparison of these two examples reveals the cost savings associated with going from an average site skill level of 2.6 to an average site skill level of 3.0 for the operators involved in operating this particular fleet:
Skill level 2.6=$24,829,740
Skill level 3.0=$23,123,880
Difference=$1,705,860
   Thus, in the example provided above, the predicted cost savings for raising the average site skill level from 2.6 to 3.0 is $1,705,860 for the particular class of equipment at issue. Thus, the mine manager has a quantifiable return on investment (ROI) for the training dollars he or she invests. With this information, the site manager can take the predicted cost savings associated with raising the average site skill level and compare that to the costs entailed in providing the training recommended in step 18 of FIG. 1.

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

### REFERENCES

1. Bird, Jr., Frank E. and George L. Germain, Loss Control Management: Practical Loss Control Leadership, 2d rev. ed., Ch. 2, p. 21. International Loss Control Institute, Inc. Loganville, Ga. (1992).

We claim:

1. A method for increasing productivity and safety in the mining and heavy construction industries comprising:
(a) evaluating equipment operator skills at a site;
(b) correlating the evaluated operator skills to operator skill levels;
(c) calculating an average site skill level for the site;
(d) correlating the average site skill level to an incident rate;
(e) establishing equipment costs for the site based on the incident rate from step (d);
(f) calculating incident rates for different average site skill levels;
(g) projecting equipment costs for different average site skill levels based on the incident rates calculated in step (f);
(h) comparing the equipment costs from step (e) to the projected equipment costs from step (g);
(i) wherein the site utilizes one or more classes of equipment, using the average site skill level to generate a productivity factor for each class of equipment;
(j) calculating production costs for a class of equipment based on the productivity factors generated in step (i);
(k) calculating production costs for different productivity factors;
(l) comparing the production costs from step (j) to the production costs from step (k) to generate cost-benefit information for a manager deciding whether to implement a training program; and
(m) generating a report with recommended training based on the skill evaluations and desired equipment cost and/or productivity factor goals established by the site manager based on the information generated in steps (h) and (l).

2. The method of claim 1, wherein the average site skill level is for a particular class of equipment.

3. The method of claim 1, wherein the method applies to an operation, and wherein the average site skill level is for the operation as a whole.

4. The method of claim 1, wherein the step of calculating incident rates for different average site skill levels is performed using the following algorithm:
IR=ΣC*200,000/Σt_{EE}(c₁+c₂+c₃ . . . )200,000/Σt_{EE}
wherein IR is the incident rate, C represents the cases of reportable incidents for the site, t_{EE} represents the total time in hours of employee exposure at the site, and c_{α} represents the cases of reportable incidents for each individual operator at a particular skill level over the period of his or her employment at the site.

5. The method of claim 1, wherein the step of projecting equipment costs for different average site skill levels involves three categories of incidents,
wherein the three categories of incidents are major, serious and minor;
wherein each category of incident has an assigned dollar value;
wherein the equipment costs for the major incident category are calculated by multiplying the incident rate by the dollar value assigned to that category;
wherein the equipment costs for the serious incident category are calculated by multiplying the incident rate by ten and then by the dollar value assigned to that category; and
wherein the equipment costs for the minor incident category are calculated by multiplying the incident rate by thirty and then by the dollar value assigned to that category.

6. The method of claim 1, wherein the step of using the average site skill level to generate a productivity factor for each class of equipment is performed using the following algorithm:
PF=O_{Ap}*E
wherein PF is the productivity factor, O_{Ap} represents the operator percentage of efficiency for a particular skill level, and E represents the efficiency for a specified operation based on original equipment manufacturer (OEM) specifications.

7. The method of claim 1, wherein the step of calculating production costs for a class of equipment is performed using the following algorithm:
PC=PF*ΣEq*ΣOt*ΣHCO
wherein PC is the production cost, PF represents the productivity factor for a given class of equipment, Eq represents the number of pieces of equipment in the class, Ot represents the hours of operation for each piece of equipment in the class, and HCO represents the hourly cost of operation for each piece of equipment.

8. The method of claim 7, wherein the hourly cost of operation comprises purchase, finance, depreciation, repair and maintenance, consumables and/or labor costs associated with the equipment.

9. The method of claim 1, further comprising:
(n) assessing an operator's knowledge in one or more areas and assigning a knowledge assessment score to the operator;
(o) storing the knowledge assessment score for the operator in a database; (p) providing computer-based instruction designed to improve the operator's knowledge assessment score;
(q) repeating steps (n) through (p) until the operator's knowledge assessment score is acceptable.
